(19) United States
(12) Patent Application Publication
(10) Pub. No.: US 2018/0170293 A1
(43) Pub. Date: Jun. 21, 2018

(54) VEHICLE AND METHOD FOR CONTROLLING THE SAME

(71) Applicants: HYUNDAI MOTOR COMPANY, Seoul (KR); KIA MOTORS CORPORATION, Seoul (KR)

(72) Inventors: Sihyun JOO, Seoul (KR); Jongmin OH, Suwon-si (KR); Jungsang MIN, Seoul (KR)

(73) Assignees: HYUNDAI MOTOR COMPANY, Seoul (KR); KIA MOTORS CORPORATION, Seoul (KR)

(21) Appl. No.: 15/818,617

(22) Filed: Nov. 20, 2017

(30) Foreign Application Priority Data
Dec. 16, 2016 (KR) 10-2016-0172356

(51) Int. Cl. B60R 16/037; G06F 3/0488; G06F 17/27

(52) U.S. Cl. CPC B60R 16/037; G06F 17/30716; G06F 17/273; G06F 3/04883

(57) ABSTRACT

A touch input device for a vehicle is disclosed. The touch input device is installed next to the driver seat, and configured to receive the driver's touch input. In response to a series of gestures on the touch input device, a computing system of the vehicle analyzes the series of gestures and identifies at least one character corresponding to the gestures. The computing system identifies a group of input gestures, identifies at least one character corresponding to the group of input gestures, and prompts the identified character on a display for the driver's correction.

### CROSS-REFERENCE TO RELATED APPLICATION

This application claims priority to and the benefit of Korean Patent Application No. 10-2016-0172356, filed on Dec. 16, 2016, the disclosures of which is incorporated herein by reference in its entirety.

### BACKGROUND

### 1. Field

The present disclosure relates to a vehicle with a touch input device for detecting gestures and method for controlling the same.

### 2. Discussion of Related Art

With the advance of technology, vehicles tend to provide various functions for convenience of people in the vehicle apart from the basic driving function.

As the functions provided by the vehicle vary, a burden for the driver to manipulate the functions in the vehicle may increase. The increase of the burden of manipulation may be a factor to distract and disturb the driver from safe driving. As the number of the functions increases, difficulty of manipulation may increase, so some inexperienced drivers who are not good at manipulation of the vehicle might not properly take advantage of the functions provided by the vehicle.

To solve this problem, studies on input devices for vehicle to reduce the burden and difficulty of manipulation for the driver are actively going on. As a typical example of the input device for vehicle, there is a touch input device for detecting touches of the driver. The driver may easily control the vehicle by touching the touch input device without need for complicated manipulation.

The disclosure of this section is to provide background of the invention. Applicant notes that this section may contain information available before this application. However, by providing this section, Applicant does not admit that any information contained in this section constitutes prior art.

### SUMMARY

Embodiments of the present disclosure provide a vehicle and method for controlling the same, by which a letter corresponding to multiple stroke gestures detected each time the number of the detected stroke gestures corresponds to a multiple of a unit is displayed.

In accordance with one aspect of the present disclosure, a vehicle includes a display configured to provide a text input interface; a touch input device configured to sequentially detect a plurality of stroke gestures for inputting text through a touch unit; a storage configured to sequentially store the detected plurality of stroke gestures; and a controller configured to control the text input interface to display text corresponding to a plurality of stroke gestures stored each time the number of the stored plurality of stroke gestures corresponds to a multiple of a predetermined unit.

The storage may comprise a first buffer configured to sequentially store the detected plurality of stroke gestures; and a second buffer configured to initialize each time the number of the plurality of stroke gestures stored in the first buffer corresponds to a multiple of the unit and store the plurality of stroke gestures stored in the first buffer.

The controller may be configured to control the text input interface to display text corresponding to a plurality of stroke gestures stored in the second buffer.

The controller may be configured to control the text input interface to display text corresponding to a plurality of stroke gestures stored in the first buffer if there is no more stroke gesture detected within a predetermined delay time from when the last one of the detected plurality of stroke gestures is finished.

The storage may be configured to initialize the first and second buffers if text corresponding to a plurality of stroke gestures stored in the first buffer is displayed.

The storage may comprise a text database, and the controller may be configured to determine that there is a typographical error existing in the displayed text if the displayed text does not exist in the text database.

The controller may be configured to control the text input interface to display similar text sets in the text database to the displayed text as recommended text sets for correction, if it is determined that there is a typographical error in the displayed text.

The controller may be configured to if it is determined that there is a typographical error in the displayed text, check similar text in the text database to the displayed text and determine a difference between the checked text and the displayed text as the typographical error.

The controller may be configured to control the text input interface to highlight the determined typographical error.

The controller may be configured to control the text input interface to correct and display the determined typographical error based on the checked similar text.

In accordance with another aspect of the present disclosure, a method for controlling a vehicle, the method includes providing a text input interface; sequentially detecting a plurality of stroke gestures for inputting text through a touch unit of the vehicle; sequentially storing the detected plurality of stroke gestures; and displaying text corresponding to the plurality of stroke gestures stored each time the number of the stored plurality of stroke gestures corresponds to a multiple of a predetermined unit through the text input interface.

The sequentially storing the detected plurality of stroke gestures may comprise sequentially storing the detected plurality of stroke gestures in a first buffer of the vehicle; and initializing a second buffer of the vehicle each time the number of the plurality of stroke gestures stored in the first buffer corresponds to a multiple of the unit and storing the plurality of stroke gestures stored in the first buffer in the second buffer.

The displaying text may comprise displaying text corresponding to a plurality of stroke gestures stored in the second buffer through the text input interface.

The displaying text may comprise displaying text corresponding to a plurality of stroke gestures stored in the first buffer through the text input interface if there is no more stroke gesture detected within a predetermined delay time from when the last one of the detected plurality of stroke gestures is finished.

The method may further comprise initializing the first and second buffers if text corresponding to a plurality of stroke gestures stored in the first buffer is displayed.

The method may further comprise storing a text database; and determining that there is a typographical error existing in the displayed text if the displayed text does not exist in the text database.

The method may further comprise displaying similar text sets in the text database to the displayed text as recommended text sets for correction through the text input interface, if it is determined that there is a typographical error in the displayed text.

The method may further comprise if it is determined that there is a typographical error in the displayed text, checking similar text in the text database to the displayed text and determining a difference between the checked text and the displayed text as the typographical error.

The displaying text may comprise highlighting the determined typographical error.

The displaying text may comprise correcting and displaying the determined typographical error based on the checked similar text.

### BRIEF DESCRIPTION OF THE DRAWINGS

The above and other aspects, features and advantages of the present disclosure will become more apparent to those of ordinary skill in the art by describing in detail exemplary embodiments thereof with reference to the accompanying drawings, in which:

FIG. 1 shows the exterior of a vehicle, according to an embodiment of the present disclosure;

FIG. 2 shows internal features of a vehicle, according to an embodiment of the present disclosure;

FIG. 3 is a control block diagram of a vehicle, according to an embodiment of the present disclosure;

FIGS. 4A to 4C show a touch input device, according to an embodiment of the present disclosure;

FIGS. 5A to 5C show a touch input device, according to another embodiment of the present disclosure;

FIG. 6 shows a text input interface displayed on a display, according to an embodiment of the present disclosure;

FIGS. 7A to 7G show how to input letters corresponding to letter input gestures, according to an embodiment of the present disclosure;

FIG. 8 shows how to display letters corresponding to letter input gestures of FIGS. 7A to 7G;

FIGS. 9A and 9B show how to display a letter corresponding to stroke gestures, according to an embodiment of the present disclosure;

FIGS. 10A and 10B show how to display a letter corresponding to stroke gestures, according to another embodiment of the present disclosure;

FIGS. 11A and 11B show how to display a letter corresponding to stroke gestures, according to another embodiment of the present disclosure;

FIGS. 12A and 12B show how to display a letter corresponding to stroke gestures, according to another embodiment of the present disclosure;

FIG. 13 shows how to show a typographic error in letters displayed through a text input interface, according to an embodiment of the present disclosure;

FIG. 14 shows how to show recommended letter sets for correction through a text input interface, according to an embodiment of the present disclosure; and

FIG. 15 is a flowchart illustrating a method for controlling a vehicle, according to an embodiment of the present disclosure.

### DETAILED DESCRIPTION OF EMBODIMENTS

Embodiments of a vehicle and method for controlling the same will now be described in detail with reference to accompanying drawings.

An aspect of the invention discloses a touch input device installed in a vehicle. The touch input receives the driver's touch input. When multiple-stroke gestures are received, the touch input device analyzes the multiple-stroke gestures, identifies a character corresponding to multiple-stroke gestures, and identifies a command for controlling the vehicle using the identified character.

In embodiments, the touch input device is installed next to the driver seat, between to the driver seat and the front passenger seat. The touch input device includes a curved touch-responsive surface facing upwards. The curved surface forms a recess when viewed in a vertical cross section. In embodiments, the curved surface includes a central portion and a peripheral portion, land the central portion and the peripheral portion have different curvatures such that the driver can identify the central portion without looking at the curved surface while driving.

In embodiments, when the driver input a series of gestures on the touch input device, a computing system of the vehicle analyzes the series of gestures and identifies at least one character corresponding to the gestures. In embodiments, the computing system identifies a group of gestures and look up at least one character corresponding to the group of gestures, prompts the identified character on a display for the driver's correction. In embodiment, the computing system stores input gestures in a buffer memory, and counts the number of input gestures in the buffer memory, and look-up or identify at least one character corresponding the input gestures in the buffer memory, when the number of gestures in the buffer memory reaches a predetermined number. Subsequently, the computing system code is a display of the vehicle to display the identified character corresponding to the input gestures in the buffer memory, and cleared the buffer memory. In embodiments, even when the count of gestures in the buffer memory is less than the predetermined number, no input is detected for a reference time period since the last input on the touch input device, the computing system initiates a process to identify at least one character corresponding to the input gesture(s) stored in the buffer memory so far.

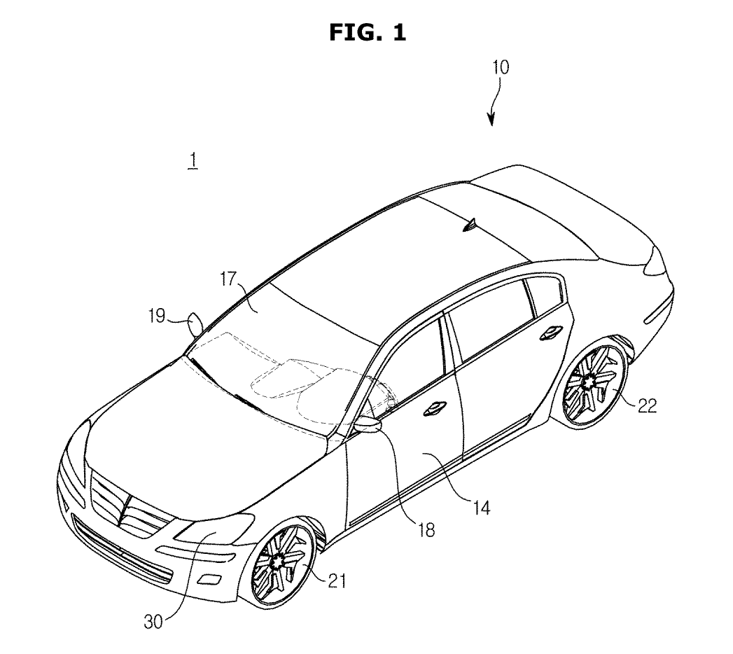

FIG. 1 shows the exterior of a vehicle, according to an embodiment of the present disclosure.

Referring to FIG. 1, a vehicle 1 includes main body 10 forming the exterior of the vehicle 1, wheels 21 and 22 for moving the vehicle 1, doors 14 for shielding the interior of the vehicle 1 from the outside, a front window 17 through which the driver can see a view ahead of the vehicle 1, and side mirrors 18, 19 for helping the driver see areas behind and to the sides of the vehicle 1.

The wheels 21 and 22 include front wheels 21 equipped on the front side of the vehicle 1 and rear wheels 22 equipped on the rear side of the vehicle 1, and the front wheels 21 or rear wheels 22 may move the main body 10 forward or backward with turning force provided from a driving unit 700, which will be described later.

The doors 14 are attached onto the left and right sides of the main body 10, and opened for the driver to enter and exit the vehicle 1 and closed for shielding the interior of the vehicle 1 from the outside.

The front glass 17, also termed as a windshield glass, is placed on the top front of the main body 10 for securing a front view for the driver inside the vehicle 1.

The side mirrors 18 and 19 include a left side mirror 18 and a right side mirror 19 placed on the left and right sides of the main body 10, respectively, for helping the driver obtain views behind and to the sides of the vehicle 1.

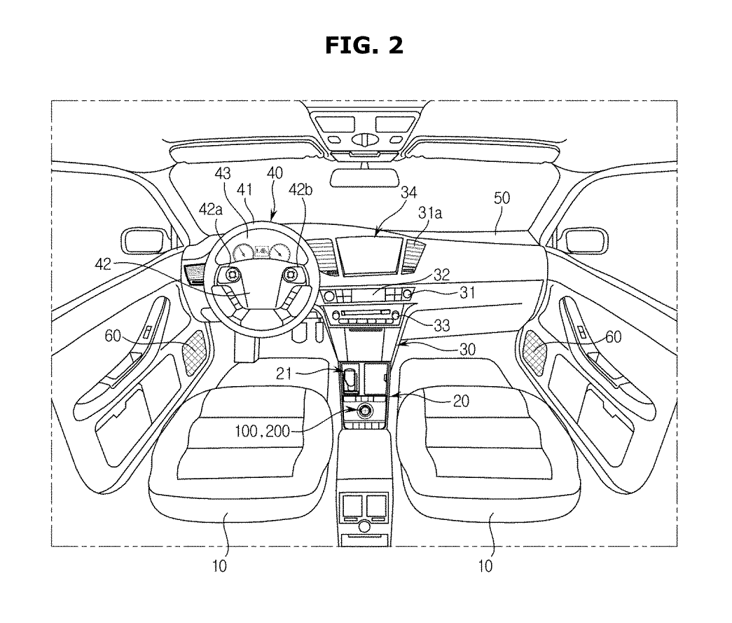

FIG. 2 shows internal features of a vehicle, according to an embodiment of the present disclosure.

Referring to FIG. 2, the vehicle 1 may include seats 10 reserved for driver and passengers to sit on, and a dashboard 50 having a gear box 20, a center fascia 30 and a steering wheel 40.

In the gear box 20, a gearshift 24 for shifting gears of the vehicle 1, and a dial controller 22 for controlling functions of the vehicle 1 to may be installed.

The steering wheel 40 equipped on the dashboard 50 is a tool to control a traveling direction of the vehicle 1, and may include a rim 41 to be held by the driver and a spoke 42 connected to a steering system of the vehicle 1 for connecting the rim 41 to a hub of a rotation shaft for steering. In an embodiment, control devices 42a, 42b may be formed on the spoke 42 to control various devices, e.g., the audio system, in the vehicle 1.

A cluster 43 may have a speed gauge to indicate speed of the vehicle and an rpm gauge to indicate rpm of the vehicle. The driver may check the information relating to the vehicle at a glance. The cluster 43 may also indicate information about the vehicle 1, especially, about traveling of the vehicle 1. For example, the cluster 43 may indicate a distance to empty (DTE) based on the remaining amount of fuel, navigation information, audio information, and/or the like.

In order for the driver to check the vehicle-related information without excessively turning his/her eyes away from the forward direction while driving, the cluster 43 may be equipped in an area of the dashboard 50 to face the steering wheel 40.

Although not shown, a Head Up Display (HUD) for displaying visual information to be provided for the driver may also be equipped on the dashboard 50.

In the center fascia 30 arranged on the dashboard 50, an air conditioner 31, a clock 32, an audio system 33, a display 34, and the like may be installed.

The air conditioner 31 keeps the atmosphere inside the vehicle 1 pleasant by controlling temperature, humidity, air cleanness, and air flows inside the vehicle 1. The air conditioner 31 may include at least one vent 31a installed in the center fascia 30 for venting air. There may also be buttons or dials installed in the center fascia 30 to control e.g., the air conditioner 31. A person in the vehicle 1, e.g., the driver, may control the air conditioner 31 with the buttons arranged on the center fascia 30.

The clock 32 may be arranged around the buttons or dials for controlling the air conditioner 31.

The audio system 33 may include a control panel on which a number of buttons are arranged to perform functions of the audio system 33. The audio system 33 may provide a radio mode for radio listening and a media mode for reproducing audio files stored in various storage media.

The audio system 33 may output an audio file into sound through the speaker 60. Although FIG. 2 shows that the speaker 60 is arranged on the inner side of a door, where to arrange the speaker 60 is not limited thereto.

The display 34 may display various information relating directly or indirectly to the vehicle. For example, the display may display direct information, such as navigation information of the vehicle and information about a state of the vehicle, and indirect information, such as multimedia information including pictures or moving images provided from inside/outside of the vehicle.

The display 34 may also display a user interface to input letters. This will be described in more detail later.

The display 34 may be implemented with Liquid Crystal Displays (LCDs), Light Emitting Diodes (LEDs), Plasma Display Panels (PDPs), Organic Light Emitting Diodes (OLEDs), Cathode Ray Tubes (CRTs), etc., without being limited thereto.

The dashboard 50 may further include a touch input device 100, 200 for detecting touches of the driver to generate control commands. While the user interface for inputting letters to the display is displayed on the display, the driver may change the letter type through the touch input device 100, 200.

A vehicle displaying detected letter input gestures in strokes will now be described in detail.

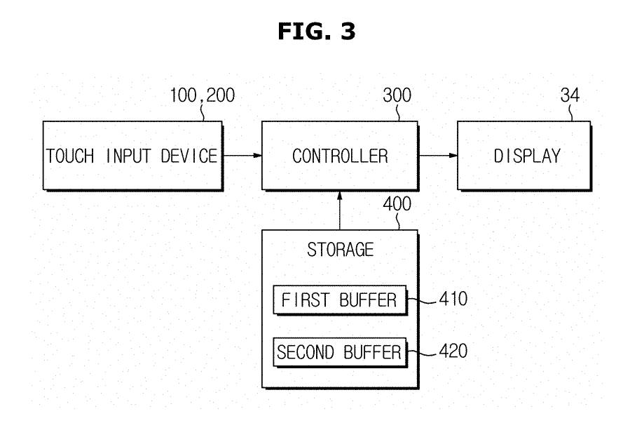

FIG. 3 is a control block diagram of a vehicle, according to an embodiment of the present disclosure.

The vehicle may include the touch input device 100, 200 for detecting a letter input gesture through a touch unit, a storage 400 for storing various information in advance, the display 34 for displaying a text input interface, and a controller 300 for controlling the text input interface to display a letter corresponding to a detected letter input gesture.

The storage 400 may store various information relating directly or indirectly to the vehicle in advance. For example, the storage 400 may store direct information, such as map information, navigation information of the vehicle, and information about a state of the vehicle, and indirect information, such as multimedia information including pictures or moving images provided from inside/outside of the vehicle in advance.

The storage 400 may further store relations between gestures detected by the touch input device 100, 200, as will be described later, and control commands, or store the user interface to be displayed on the display 34 in advance, as will be described later.

The storage 400 may also store relations of correspondence between letter input gestures comprised of detected stroke gestures and letters in advance.

Furthermore, the storage 400 may store a detected position of a stroke gesture on the touch input device 100, 200 according to a detected point of time, as will be described later.

Specifically, the storage 400 may include a first buffer storing a plurality of detected stroke gestures sequentially, and a second buffer initialized each time the number of the plurality of stroke gestures stored in the first buffer corresponds to a multiple of a unit and storing a plurality of stroke gestures stored in the first buffer. This will be described in more detail later.

As such, the information stored in advance in the storage 400 may be provided to the controller 300 to be used as a basis for control of the vehicle.

The touch input device 100, 200 may detect a touch of the user, e.g., the driver or passenger. The touch input device 100, 200 may be implemented in various ways within the technical scope of touch detection. For example, the touch input device 100, 200 may be in plain shape allowing detection of touches, or otherwise in the form of a circle or ellipse.

In an embodiment, the touch input device 100, 200 may be formed to have an inwardly sunken area to detect touches.

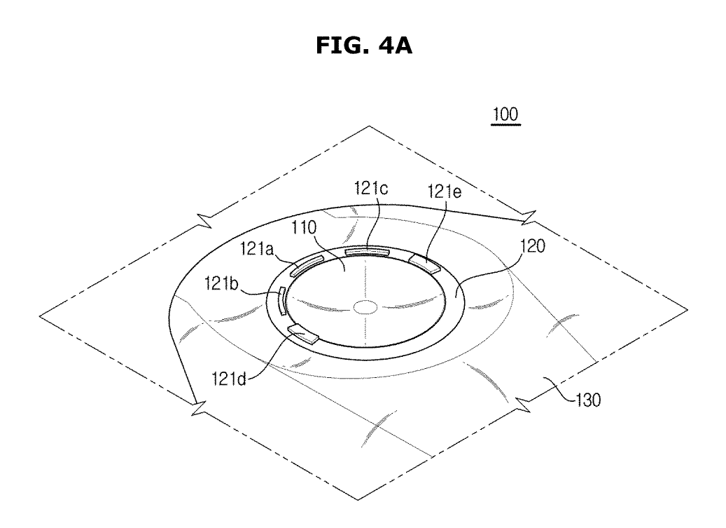

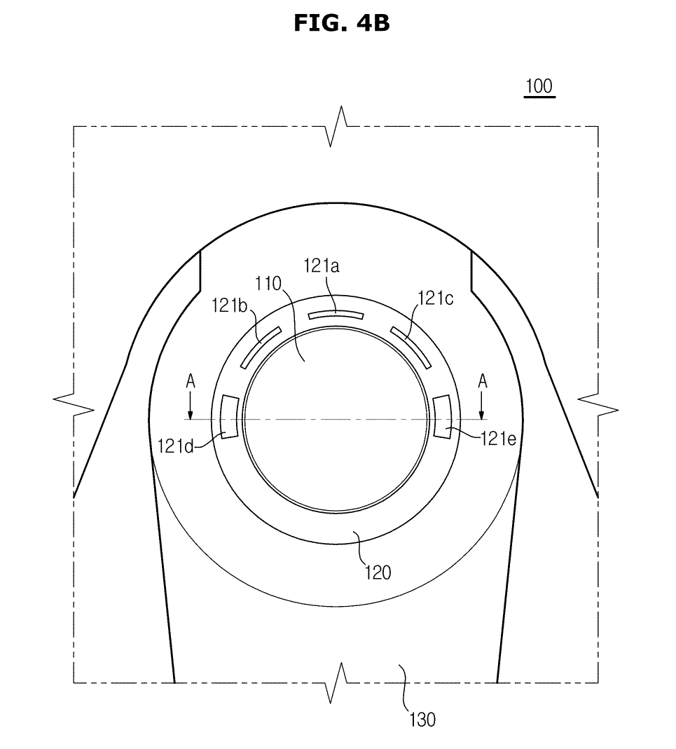

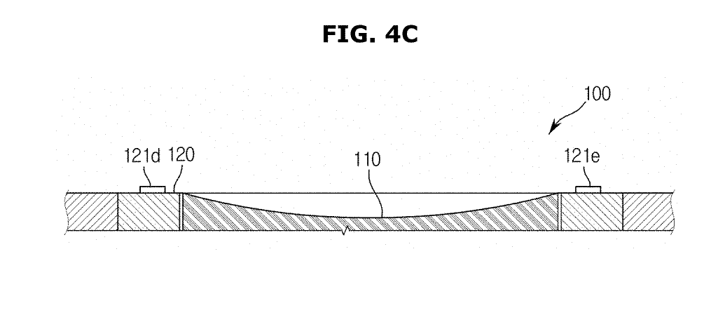

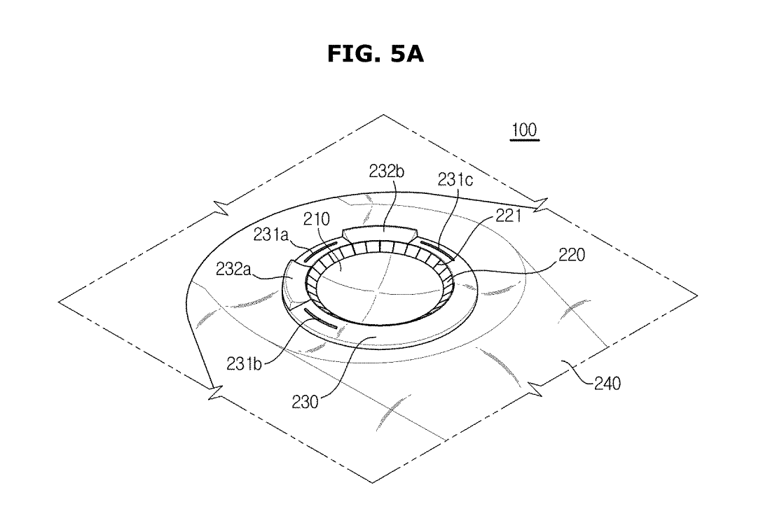

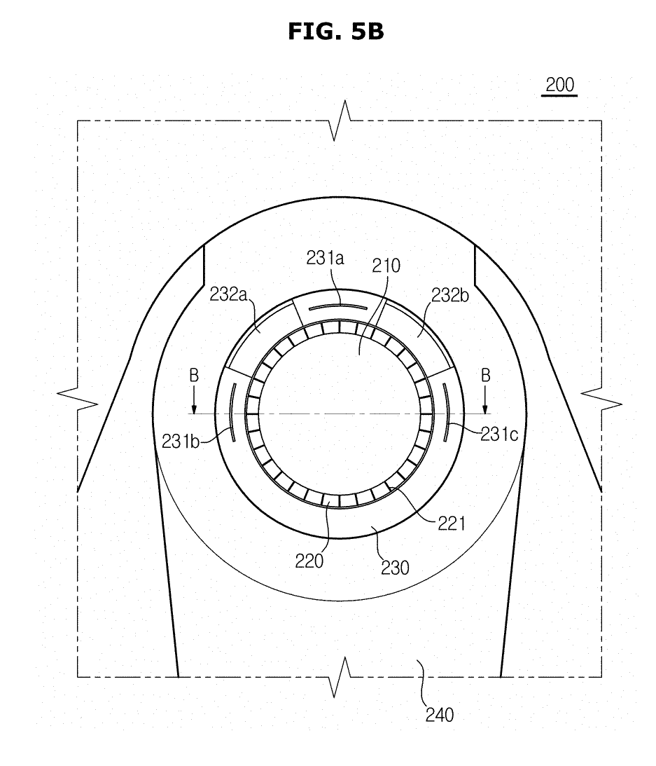

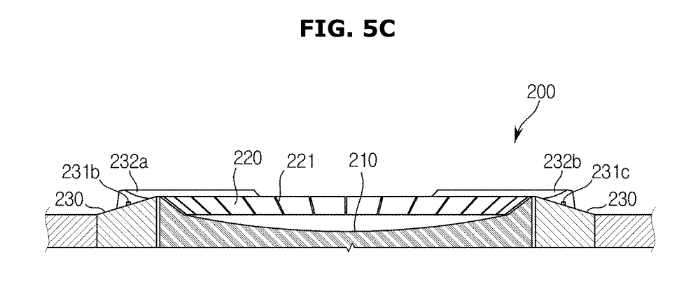

FIGS. 4A to 4C show a touch input device, according to an embodiment of the present disclosure, and FIGS. 5A to 5C show a touch input device, according to another embodiment of the present disclosure.

FIG. 4A is a perspective view of a touch input device, according to an embodiment of the present disclosure, FIG. 4B is a plan view of a touch input device, according to an embodiment of the present disclosure, and FIG. 4C is a cross-sectional view of a touch input device cut along a line of A-A, according to an embodiment of the present disclosure.

A touch input device shown in FIGS. 4A to 4C may include a touch unit 110 for detecting a touch of the user, and a border part 120 enclosing around the touch unit 110.

The touch unit 110 may be a touch pad to generate a signal when the user contacts or approaches it with a pointer, such as his/her finger or a touch pen. The user may input a desired control command by inputting a predetermined touch gesture to the touch unit 110.

Despite the name, the touch pad may include a touch film or touch sheet with a touch sensor. The touch pad may also include a touch panel, a display device with a touchable screen.

Recognizing the pointer's position while the pointer is not contacting but approaching the touch pad is called ‘proximity touch’, and recognizing the pointer's position when the pointer contacts the touch pad is called ‘contact touch’. Proximity touch is made by recognizing a position on the touch pad vertically corresponding to a position in the air where the pointer approaches the touch pad.

The touch pad may use resistive methods, optical methods, capacitive methods, ultrasonic methods, or pressure methods. That is, various well-known types of touch pads may be used.

The border part 120 may refer to a part that encloses around the touch unit 110, and may be formed of a separate member from that of the touch unit 110. There may be key buttons or touch buttons 121 arranged on the border part 120 to surround the touch unit 110. The user may input a control command by a touch through the touch unit 110, or by using the button 121 arranged on the border part 120 around the touch unit 110.

In embodiments of the present disclosure, the touch input device may further include a wrist supporter 130 for supporting the wrist of the user. In this regard, the wrist supporter 130 may be located higher up than the touch unit 110. This is because when the user is making a touch on the touch unit 110 with his/her finger while putting his/her wrist on the wrist supporter 130, the wrist is protected from bending. Accordingly, it may prevent possible musculoskeletal disorders, and give more comfortable feeling of manipulation to the user.

The touch unit 110 may include a lower part than the level of a boundary with the border part 120. Specifically, the touch surface of the touch unit 110 may be located lower than the boundary between the touch unit 110 and the border part 120. For example, the touch surface may be inclined downward from the boundary with the border part 120 or may be located a step away from the boundary of the border part 120. For example, the touch unit 110 in accordance with embodiments of the present disclosure as shown in FIG. 4C includes a curved part including a concave curved area.

With the touch unit 110 including the lower part than the level of the boundary with the border part 120, the user may perceive the area and boundary of the touch unit 110 through a tactile sense. Higher touch recognition rate may be obtained in the center part of the touch unit 110 of the touch input device. Since the user may intuitively perceive the touch area and boundary through a tactile sense while trying to input a touch, the user may input the touch in an accurate position, thereby improving touch input accuracy.

The touch unit 110 may include a concave area. The concave form is a form of a dent or a sunken form, including the form that comes inside not only roundly but also slantingly or stepwise.

Referring to FIG. 4C, the touch unit 110 may include a concave curved area. The curve of the touch unit 110 may have different curvatures. For example, the touch unit 110 may be formed such that a curvature of the center part is small (which means the curvature radius is large), and a curvature near the outer side is large (which means the curvature radius is small).

With the curved surface included in the touch unit 110, the user may have better feeling of touch (or feeling of manipulation) while making touches. The curved area of the touch unit 110 may be formed to be similar to the trajectories to be drawn by movements of a finger tip of a human when he/she is making movements, such as moving the finger while fixing the wrist, or such as turning or twisting the wrists while opening the finger.

The touch unit 110 may be implemented in a round form. In this case, it may be easy to form the concave curved area. Moreover, being implemented in the round form, the touch unit 110 may allow the user to easily make rolling or spinning gestures because the user may sense the round touch area of the touch unit 110 through a tactile sense.

Being implemented as the curved plane, the touch unit 110 may allow the user to be able to know intuitively of where his/her finger is on the touch unit 110. The curved touch unit 110 may make the slope of the touch unit 110 different at every point. Accordingly, the user may know intuitively of where his/her finger is on the touch unit 110 through a sense of the slope felt by his/her finger. This feature may help the user input a desired gesture and improve input accuracy of the gesture by providing feedback about where his/her finger is on the touch unit 110 while the user is inputting the gesture to the touch unit 110 with his/her eyes fixed on somewhere else than the touch unit 110.

On the contrary to what is described above, a touch input device according to FIGS. 5A to 5C may have a concave area divided into center and outside.

FIG. 5A is a perspective view of a touch input device, according to another embodiment of the present disclosure, FIG. 5B is a plan view of a touch input device, according to another embodiment of the present disclosure, and FIG. 5C is a cross-sectional view of a touch input device cut along a line of B-B, according to another embodiment of the present disclosure.

A touch input device 200 as shown in FIGS. 5A to 5C may include a touch unit 210, 220 for detecting a touch of the user, and a border part 230 enclosing around the touch unit 210, 220.

How the touch unit 210, 220 detects touches are the same as in FIGS. 4A to 4C.

The border part 230 may refer to an area that encloses around the touch unit 210, 220, and may be formed of a separate member from that of the touch unit 210, 220. There may be key buttons 232a, 232b or touch buttons 231a, 231b, 231c arranged on the border part 230 to surround the touch unit 210, 220. The user may make a gesture on the touch unit 210, 220, or may input a signal using the buttons 231, 232 arranged on the border part 230 around the touch unit 210, 220.

Furthermore, like FIGS. 4A to 4C, the touch input device 200 may further include a wrist supporter 240 located down the gesture input means for supporting a wrist of the user.

Referring to FIG. 5C, the touch unit 210, 220 may include a lower part than the level of a boundary with the border part 230. Specifically, the touch surface of the touch unit 210, 220 may be located lower than the boundary between the touch unit 210, 220 and the border part 230. For example, the touch surface may be inclined downward from the boundary with the border part 230 or may be located a step away from the boundary of the border part 230. In the meantime, as shown in FIG. 5C, the touch unit 210, 220 may include a gesture input unit 210 having a concave curved form.

As shown in FIGS. 5A to 5C, the touch unit 210, 220 may include a concave area.

In another embodiment, the touch unit 210, 220 may include a swiping input unit 220 located along the circumference of the gesture input unit 210 to be slanted downward. If the touch unit 210, 220 has a round form, the gesture input unit 210 may be in the form of a part of a spherical surface, and the swiping input unit 220 may be formed to surround the circumference of the curved gesture input unit 210.

The swiping input unit 220 may detect swiping gestures. For example, the user may input a swiping gesture along the swiping input unit 220 having the round form. The user may input a swiping gesture clockwise or counterclockwise along the swiping input unit 220.

The swiping input unit 220 may include a plurality of division lines 221. The division lines 221 may provide visual or tactile information about a relative position for the user. For example, the division lines 221 may be engraved or embossed. The division lines 221 may be arranged at uniform intervals. Accordingly, the user may intuitively know of the number of the division lines 221 that his/her finger has passed while in a swiping motion, and thus elaborately adjust the length of the swiping gesture.

In an embodiment, a cursor to be displayed on the display 34 may be moved according to the number of the division lines 221 that the finger has passed in the swiping gesture. If various selected letters are consecutively displayed on the display 34, selection of a letter may be moved over to the next letter each time a single division line 221 is passed in the swiping motion of the user.

In embodiments of the present disclosure as shown in FIGS. 5A to 5C, an inclination of the swiping input unit 220 may be greater than a tangential inclination of the gesture input unit 210 on the border between the swiping input unit 220 and the gesture input unit 210. With an inclination of the swiping input unit 220 steeper than that of the gesture input unit 210 while the user is making a gesture on the gesture input unit 210, the user may intuitively perceive the gesture input unit 210. Meanwhile, recognition of a touch on the swiping input unit 220 may be disabled while a gesture is being input to the gesture input unit 210. Accordingly, even if the user reaches the boundary with the swiping input unit 220 while inputting a gesture to the gesture input unit 210, the gesture input to the gesture input unit 210 and a swiping gesture input to the swiping input unit 220 may not overlap.

The gesture input unit 210 and the swiping input unit 220 may be integrally formed as the touch unit 210, 220. Touch sensors may be arranged separately for the gesture input unit 210 and the swiping input unit 220 or a single touch sensor may be arranged for both of them. If there is a single touch sensor for the gesture input unit 210 and the swiping input unit 220, the controller 400 may distinguish a touch signal to the gesture input unit 210 from that to the swiping input unit 220 by dividing a touch area of the gesture input unit 210 and a touch area of the swiping input unit 220.

The touch input device 200 may further include a button input means 231, 232. The button input means 231, 232 may be located around the touch unit 210, 220. The button input means 231, 232 may include touch buttons 231a, 231b, 231c for performing designated functions when touched by the user, or pressure buttons 232a, 232b for performing designated functions while changing their positions by force applied by the user.

Turning back to FIG. 3, the display 34 may provide the text input interface for allowing the driver to easily input text. The text input interface may include various objects in order to provide an environment allowing text input.

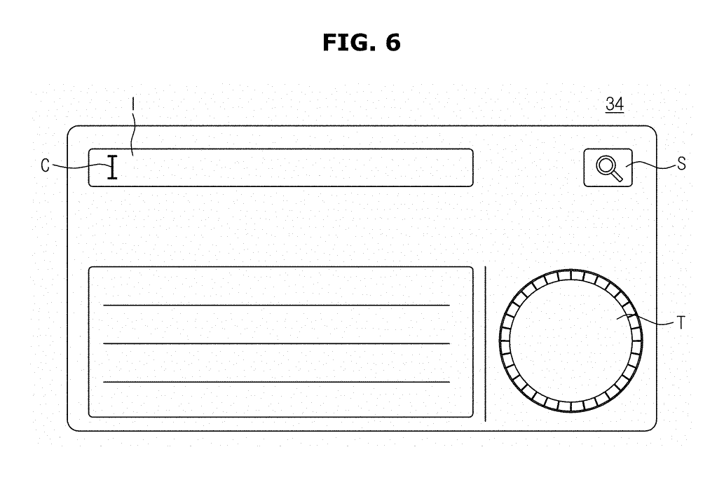

FIG. 6 shows a text input interface displayed on a display, according to an embodiment of the present disclosure.

Referring to FIG. 6, a text input interface in accordance with an embodiment may include a gesture display area T for visually representing a letter input gesture detected by the touch input device 200, an input letter display area I for displaying a letter corresponding to a detected letter input gesture, a cursor C for indicating where to display a letter corresponding to a detected letter input gesture, and a searching icon S for searching for information relating to input text. This is, however, by way of example, and the text input interface may only include some of the aforementioned items or additionally include other items than the aforementioned items.

The controller 300 may determine a letter corresponding to a letter input gesture detected through the touch unit of the touch input device 200, and control the text input interface to display the determined letter. The letter input gesture may refer to a gesture for inputting a letter as a syllable.

Once a single letter input gesture is detected, the controller 300 may determine a letter as a single syllable corresponding to the letter input gesture after a predetermined delay time from when the letter input gesture is finished. Once the letter is determined, the controller 300 may control the text input interface to display the letter as a syllable.

On the contrary, if another letter input gesture is detected within the delay time from after the previous letter input gesture is detected, after the delay time from when the last letter input gesture is finished, the controller 300 may determine letters as syllables corresponding to the multiple letter input gestures and control the text input interface to display the determined letters as multiple syllables.

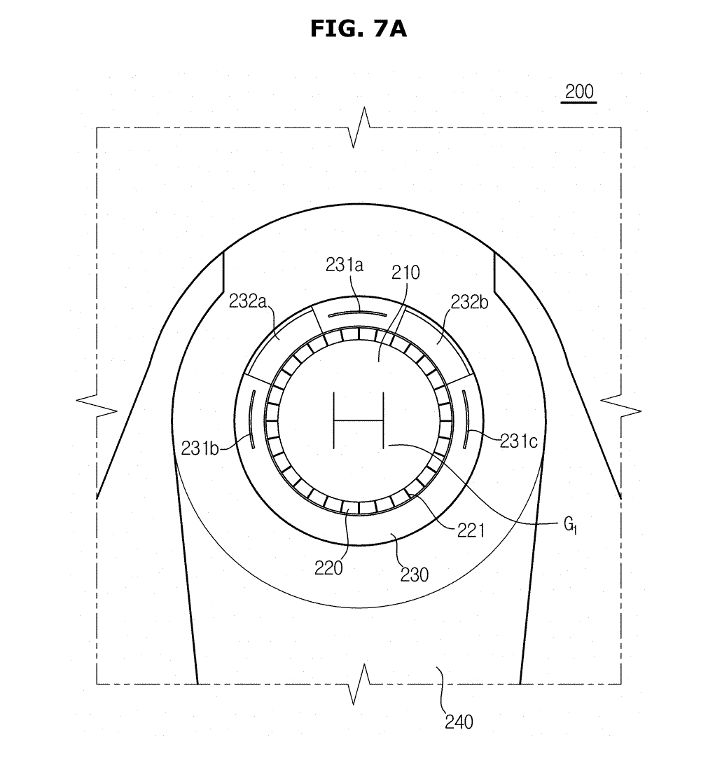

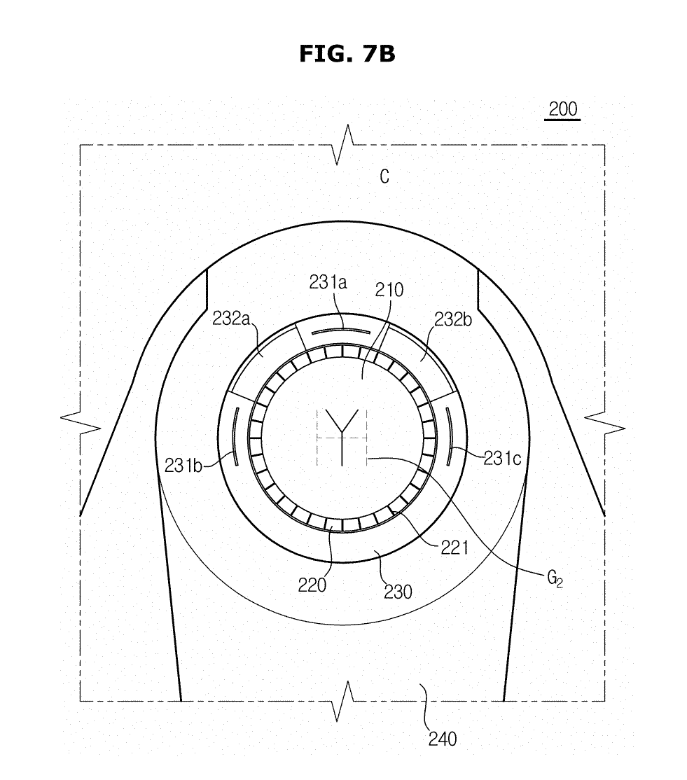

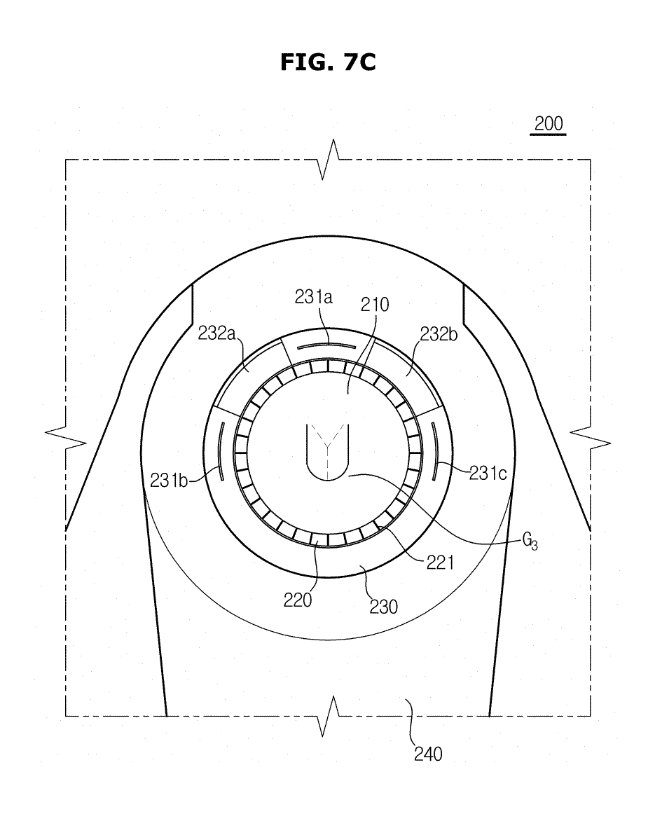

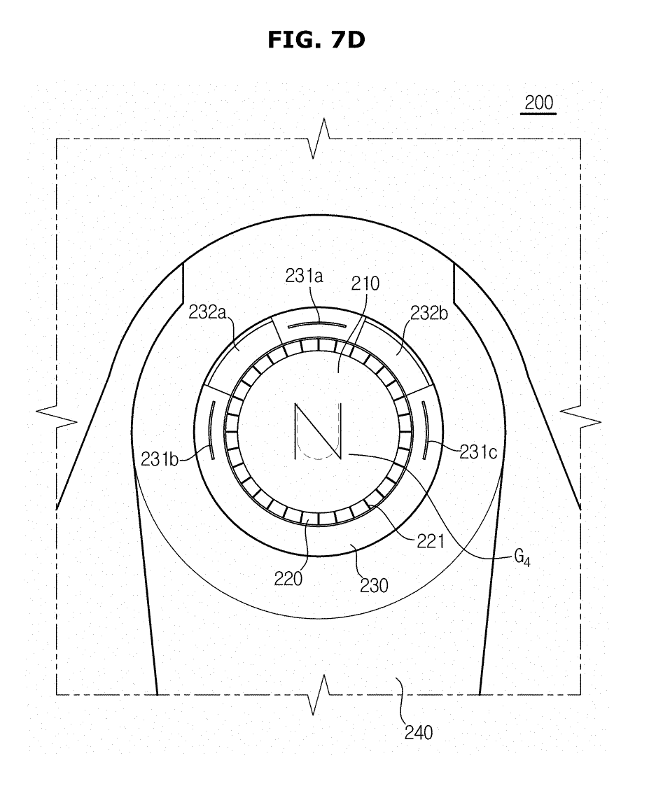

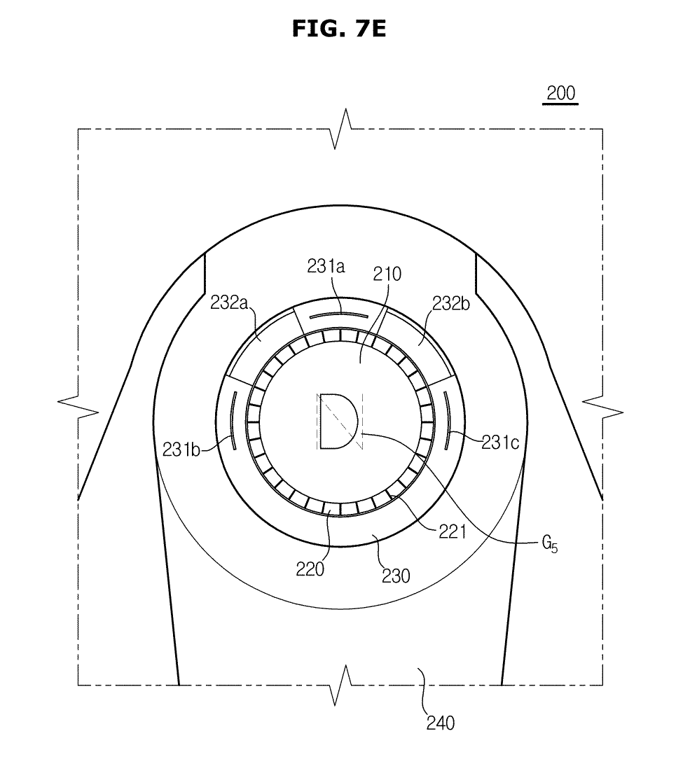

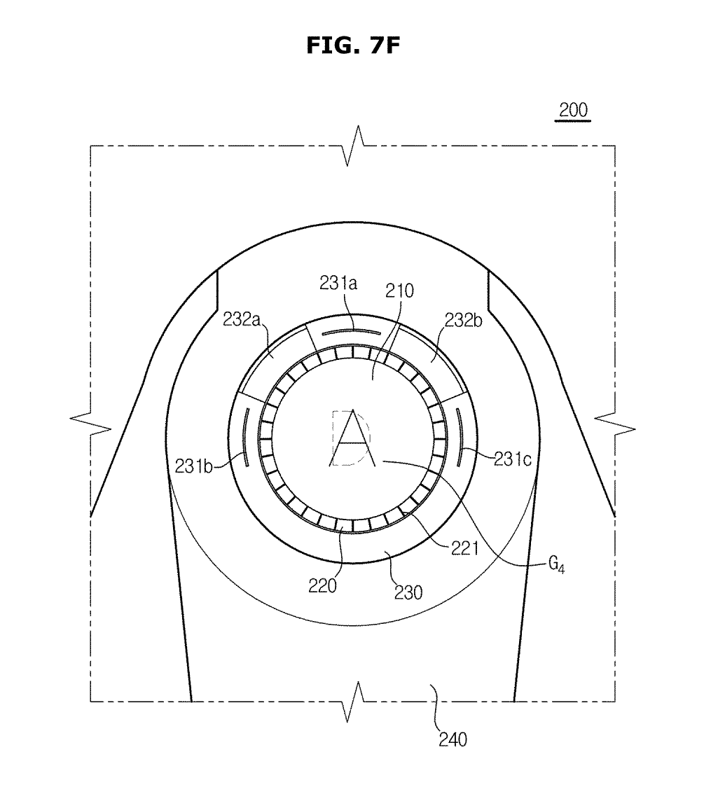

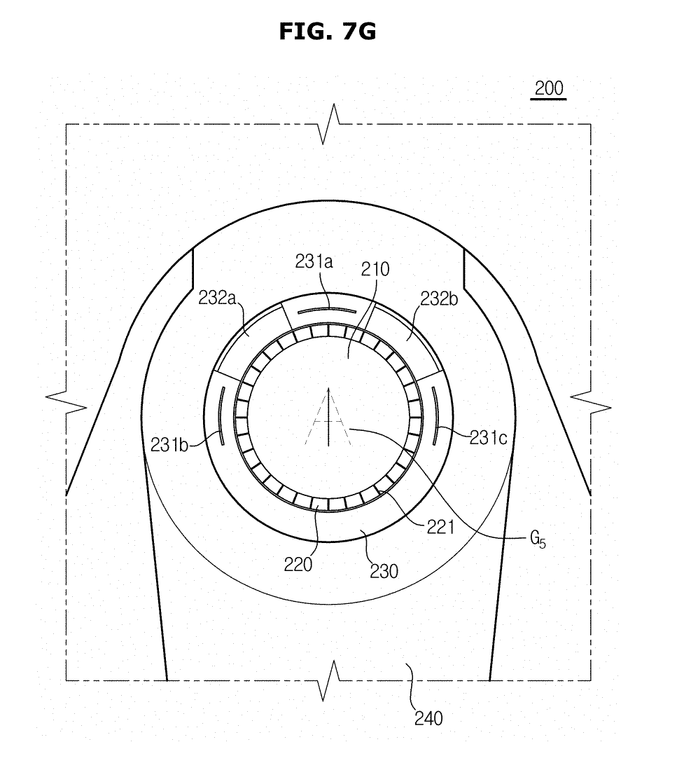

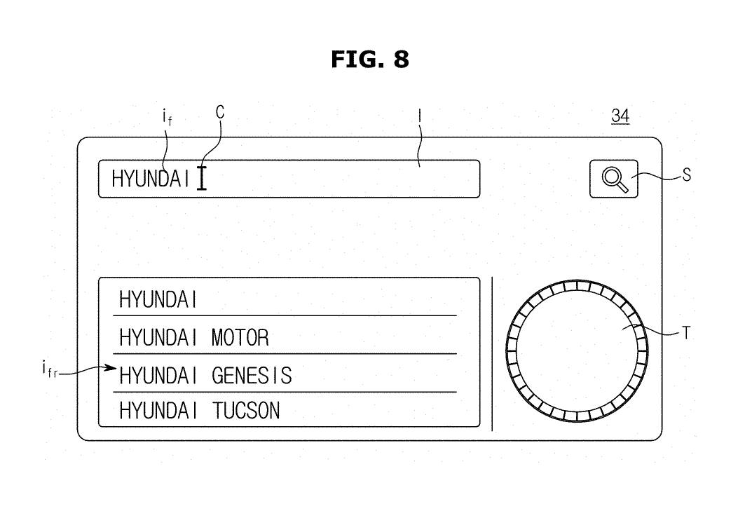

This will be described in detail in connection with FIGS. 7A to 7E and FIG. 8.

FIGS. 7A to 7E show how to input letters corresponding to letter input gestures, according to an embodiment of the present disclosure, and FIG. 8 shows how to display letters corresponding to letter input gestures of FIGS. 7A to 7E.

Referring to FIG. 7A, the user may input a letter input gesture G1 for a letter of the English alphabet “H” through the touch unit of the touch input device 200. Once the letter input gesture G1 is detected, the controller 300 may store a position of detection of the letter input gesture G1 in a first buffer 410 of the storage 400. The controller 300 may then determine whether there is another letter input gesture within a predetermined delay time from when the letter input gesture G1 is finished.

If, as shown in FIG. 7B, a letter input gesture G2 for a letter of the English alphabet “Y” is detected within the predetermined delay time after the letter input gesture G1 is finished, the controller 300 may store the letter input gesture G2 subsequently in the first buffer 410. The controller 300 may then determine whether there is still another letter input gesture within a predetermined delay time from when the letter input gesture G2 is finished.

If, as shown in FIG. 7C, a letter input gesture G3 for a letter of the English alphabet “U” is detected within the predetermined delay time after the letter input gesture G2 is finished, the controller 300 may store the letter input gesture G3 subsequently in the first buffer 410. The controller 300 may then determine whether there is still another letter input gesture within a predetermined delay time from when the letter input gesture G3 is finished.

Similarly, FIGS. 7D and 7G show a case where letter input gestures G4, G5, G6, and G7 respectively corresponding to letters of the English alphabet “N”, “D” “A”, and “I” are consecutively detected each within the delay time. If there is no other letter input gesture input within the predetermined delay time from when the letter input gesture G7 is finished, the controller 300 may control the text input interface to display a text consisting of seven alphabet letters “HYUNDAI” corresponding to the letter input gestures G1 to G7 sequentially stored in the first buffer 410.

Referring to FIG. 8, a text i_{f} consisting of seven alphabet letters “HYUNDA” corresponding to the letter input gestures G1 to G7 may be displayed in the input letter display area of the text input interface. The text input interface may also display a plurality of recommended letter sets i_{f}, related to the input letters i_{f} “HYUNDAI”.

Meanwhile, in a case of displaying letters en block corresponding to all the letter input gestures detected after the delay time from when the last letter input gesture is finished as described above, a process of correcting a typographical error in the input letters may be inconvenient.

For example, although a text consisting of seven alphabet letters “HYUNDAI” was intended to be input according to the letter input method of FIGS. 7A to 7G, “HYVNDAI” may be mistakenly inputted and displayed on the text input interface. In this case, the user may have to delete all of “VNDAI” to correct the typographic error “V” and input “UNDAI” again, or may have to move the cursor C placed on the right to “I” to the right to “V”, delete “V”, and input “U” again.

That is, in attempting to input text having multiple syllables, even if a typographical error occurs, it is hard to correct the error right away because the input letters are not immediately displayed.

To solve this, the controller 300 may control the text input interface to display the letters in the unit of a stroke gesture, which is a part of the letter input gesture.

Turning back to FIG. 3, the controller 300 may control the text input interface to display letters corresponding to a plurality of stroke gestures stored each time the number of the plurality of stroke gestures corresponds to a multiple of a predetermined unit stored in the storage 400. The term ‘stroke gesture’ may refer to a gesture comprised of a set of consecutive touches for one round to input a letter, and a letter input gesture may be comprised of at least one stroke gestures. Furthermore, the multiple of a predetermined unit may refer to a stroke interval for monitoring a typographical error, which may be determined by computation in the vehicle 1 or according to the user's input.

For this, the controller 300 may store a plurality of detected stroke gestures sequentially in the first buffer 410, initialize the second buffer 420 each time the number of stroke gestures stored in the first buffer 410 corresponds to a multiple of a unit (a reference number), and store the plurality of stroke gestures stored in the first buffer 410 in the second buffer 420. Subsequently, the controller 300 may control the text input interface to display letters corresponding to the plurality of stroke gestures stored in the second buffer 420.

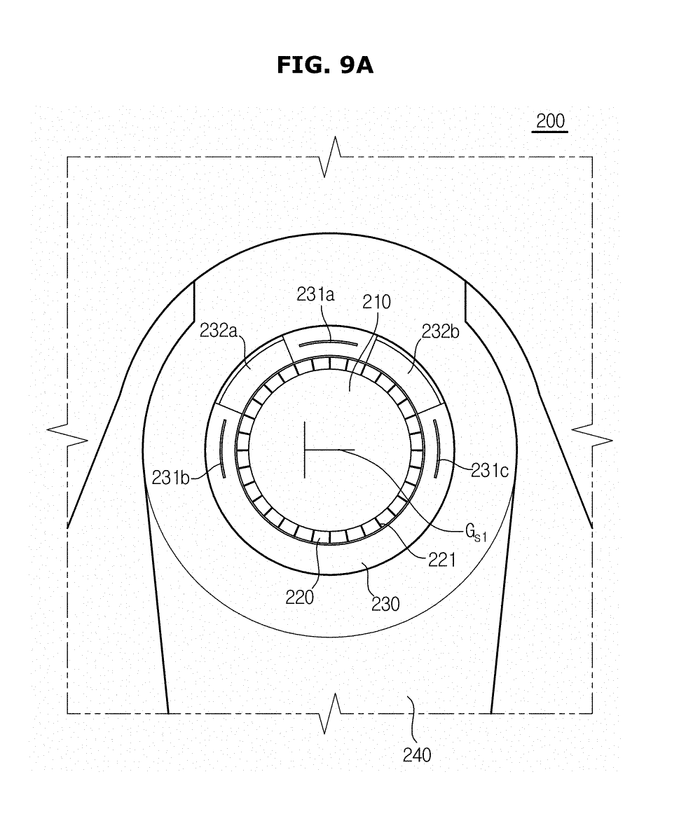

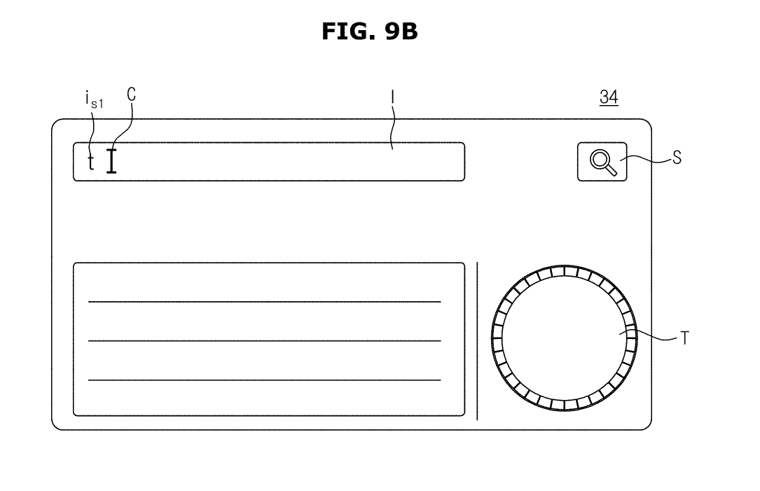

A method for displaying letters corresponding to stored stroke gestures will now be described in connection with FIGS. 9A and 9B, 10B and 10B, 11A and 11B, and 12A and 12B.

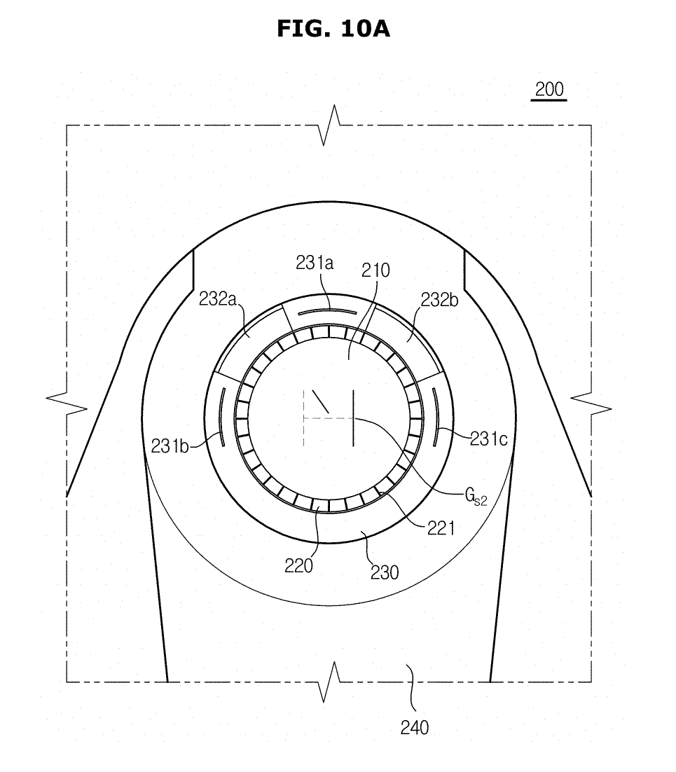

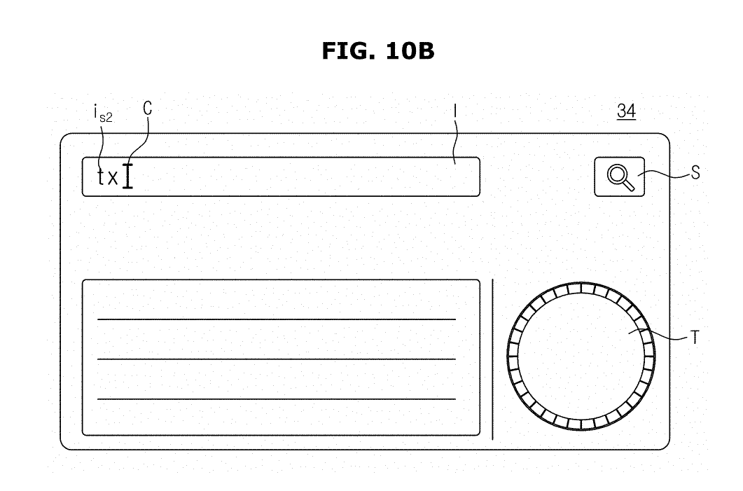

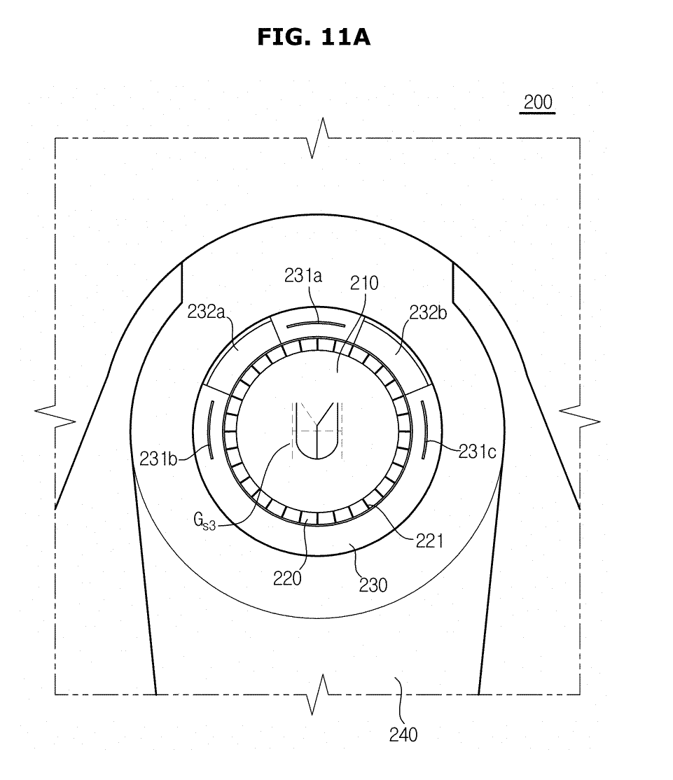

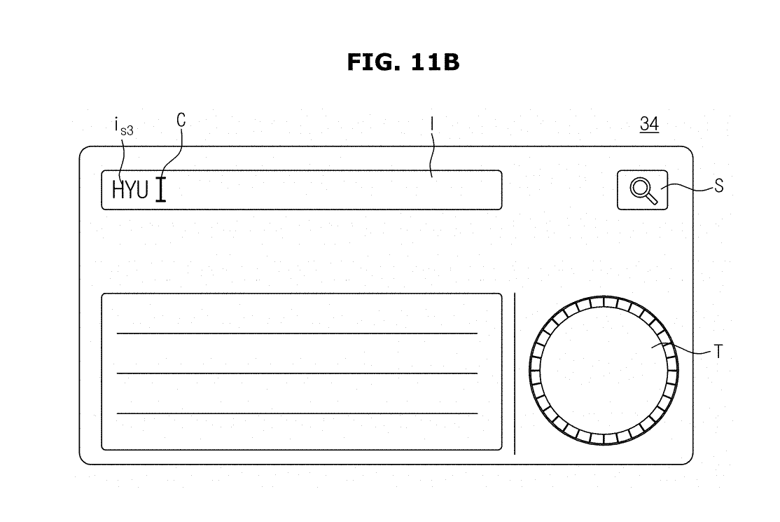

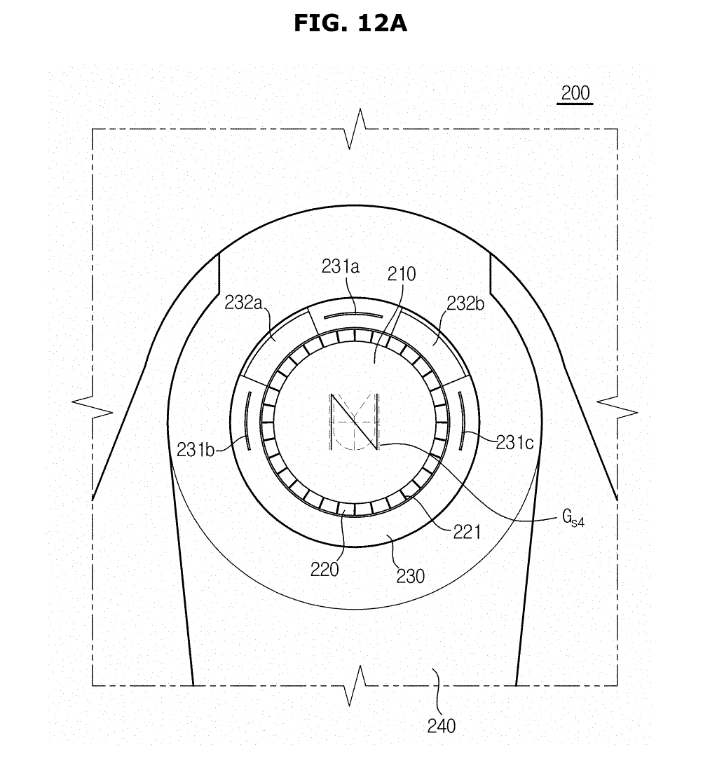

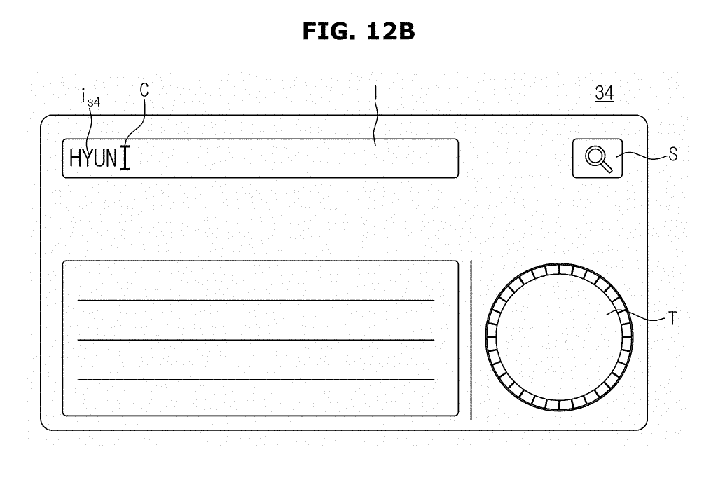

FIGS. 9A and 9B show how to display letters corresponding to stroke gestures, according to an embodiment of the present disclosure, FIGS. 10A and 10B show how to display letters corresponding to stroke gestures, according to another embodiment of the present disclosure, FIGS. 11A and 11B show how to display letters corresponding to stroke gestures, according to another embodiment of the present disclosure, and FIGS. 12A and 12B show how to display letters corresponding to stroke gestures, according to another embodiment of the present disclosure. In the following description, assume that the user attempts to input “HYUN” through the touch unit. It is also assumed that a multiple of a unit is a multiple of 2.

Referring to FIG. 9A, to input “HYUN”, the user may input two stroke gestures Gs1 for the first two strokes through the touch unit. The controller 300 may store the two stroke gestures Gs1 sequentially in the first buffer 410, initialize the second buffer 420 as the number of the stored stroke gestures is 2, and store the stroke gestures Gs1 stored in the first buffer 410 in the second buffer 420.

Since the relations of correspondence between the letter input gestures stored in the storage 400 and the letters are of complete alphabets, the controller 300 may check “t” as a complete alphabet corresponding to the two stroke gestures Gs1 stored in the second buffer 420. As a result, as shown in FIG. 9B, the letter “t” (is1) may be displayed in the input letter display area I of the text input display 34.

Subsequently, as shown in FIG. 10A, subsequent to the two stroke gestures Gs1, another two stroke gestures Gs2 may be detected by the touch unit. The controller 300 may sequentially store the two stroke gestures Gs2 in the first buffer 410 in which the stroke gestures Gs1 have already been stored. Since the number of the stroke gestures stored in the first buffer 410 is 4, which is a multiple of 2, the controller 300 may initialize the second buffer 420 to store the four stroke gestures Gs1, Gs2 sequentially stored in the first buffer 410.

The controller 300 may check alphabets “tx” corresponding to the four stroke gestures Gs1 and Gs2 stored in the second buffer 420. As a result, as shown in FIG. 10B, a text “tx” (is2) may be displayed in the input letter display area I of the text input display 34.

Subsequently, as shown in FIG. 11A, subsequent to the six stroke gestures Gs1 and Gs2, another two stroke gestures Gs3 may be detected by the touch unit. The controller 300 may sequentially store the two stroke gestures Gs3 in the first buffer 410 in which the stroke gestures Gs1 and Gs2 have already been stored. Since the number of the stroke gestures stored in the first buffer 410 is 6, which is a multiple of 2, the controller 300 may initialize the second buffer 420 to store the six stroke gestures Gs1, Gs2, Gs3 sequentially stored in the first buffer 410.

The controller 300 may check complete alphabets “HYU” corresponding to the nine stroke gestures Gs1, Gs2, and Gs3 stored in the second buffer 420. As a result, as shown in FIG. 11B, the text “HYU” (is3) may be displayed in the input letter display area I of the text input display 34.

Furthermore, as shown in FIG. 12A, subsequent to the six stroke gestures Gs1, Gs2, Gs3, another two stroke gestures Gs4 may be detected by the touch unit. The controller 300 may sequentially store the two stroke gestures Gs4 in the first buffer 410 in which the stroke gestures Gs1, Gs2, Gs3 have already been stored. Since the number of the stroke gestures stored in the first buffer 410 is 8, which is a multiple of 2, the controller 300 may initialize the second buffer 420 to store the eight stroke gestures Gs1, Gs2, Gs3, Gs4 sequentially stored in the first buffer 410.

The controller 300 may check complete alphabets “HYUN” corresponding to the eight stroke gestures Gs1, Gs2, Gs3, Gs4 stored in the second buffer 420. As a result, as shown in FIG. 12B, the letters “ [symbol] ” (is4) may be displayed in the input letter display area I of the text input display 34.

According to the aforementioned method, the user may visually check the input stroke gestures at every multiple of a unit, find a typographical error immediately, and take measures accordingly.

Alternatively, the controller 300 may control the text input interface to display letters corresponding to stroke gestures stored in the first buffer 410 after a delay time from when the last stroke gesture is finished, even if the number of the stroke gestures stored in the first buffer 410 does not correspond to a multiple of a unit. When the text is displayed, the controller 300 may initialize both the first and second buffers 410 and 420.

In the meantime, the controller 300 may determine if a typographical error exists in the text displayed according to the number of stroke gestures stored in the storage 400. For this, the storage 400 may additionally store a text database. The text database may refer to a database indexing text, such as a phone book, map information, etc.

The controller 300 may display letters corresponding to stroke gestures and at the same time, determine if the displayed letters exist in the text database stored in the storage 400. If the displayed letters do not exist in the text database, the controller 300 may determine that there is a typographical error in the displayed letters.

If it is determine that there is a typographical error in the displayed letters, the controller 300 may control the text input interface to notify the occurrence of the typographical error.

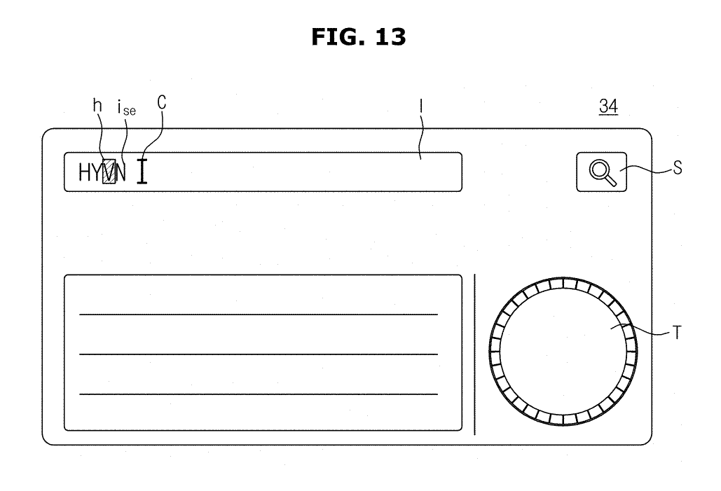

FIG. 13 shows how to show a typographical error in letters displayed through a text input interface, according to an embodiment of the present disclosure.

If it is determined that there is a typographical error in the displayed letters, the controller 400 may search the text database stored in the storage 400 for similar text to the letters displayed through the text input interface. If the most similar text has been searched for, the controller 300 may determine that a syllable in the displayed text most different from what is in the most similar text is a typographical error, and control the text input interface to highlight the syllable.

Referring to FIG. 13, if the user intended to input a text “HYVN” (ise) but there exists “HYUN” in the text database, the controller 300 may determine that “V” of “HYVN” (ise) different from “HYUN” in the text database is a typographical error. As a result, the controller 300 may highlight (h) “V” of the text (ise) “HYVN” in the input letter display area I.

Furthermore, the controller 300 may directly correct the determined typographical error and display the corrected result. According to the above embodiments, if the user inputted the text “HYVN” (ise) but there exists “HYUN” in the text database, the controller 300 may rectify the typographical error by correcting “HYVN” to “HYUN”.

Furthermore, if it is determined that a typographical error exists in the displayed text and a plurality of letter sets similar to the text displayed through the text input interface are searched for in the text database stored in the storage 400, the controller 300 may control the text input interface to display the plurality of similar letter sets as recommended letter sets for correction.

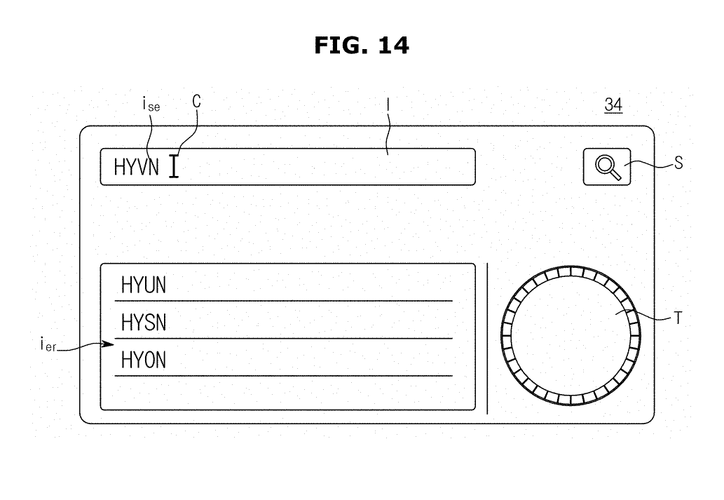

FIG. 14 shows how to show recommended letter sets for correction through a text input interface, according to an embodiment of the present disclosure.

Referring to FIG. 14, if the user inputted “HYVN” but there exist “HYUN”, “HYSN”, and “HYON” in the text database, the controller 300 may display “HYUN”, “HYSN”, and “HYON” as recommended texts for correction (ier) through the text input interface. The user may visually check the recommended letter sets for correction, and easily correct the letters by selecting one of the letter sets.

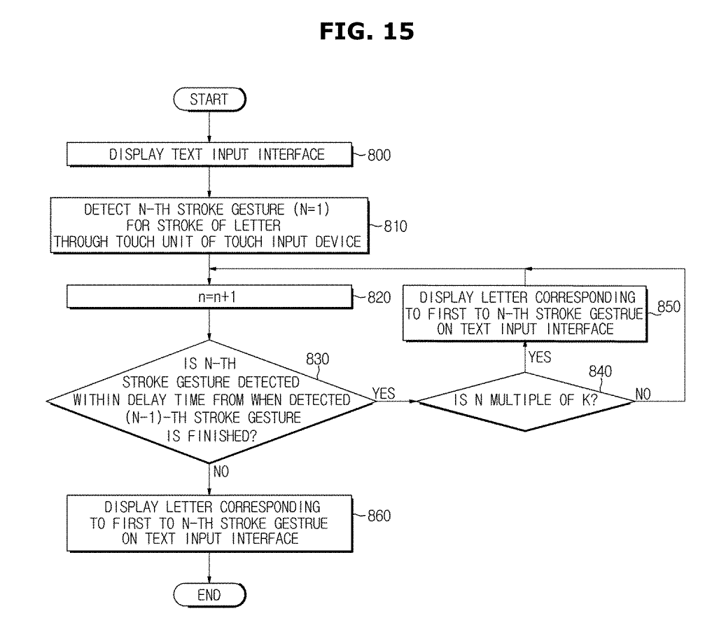

FIG. 15 is a flowchart illustrating a method for controlling a vehicle, according to an embodiment of the present disclosure.

First, the vehicle 1 displays a text input interface, in 800. The text input interface may refer to an interface for providing an environment allowing the user to input text, and may be displayed through the display 34 of the vehicle 1.

Once the text input interface is displayed, the n-th stroke gesture for a stroke of a letter may be detected through the touch unit of the touch input device 200, in 810. Let an initial value of n be one.

The n increases by one, in 820.

Subsequently, the vehicle 1 determines if the n-th stroke gesture was detected within a delay time from when the detected (n-1)-th stroke gesture had been finished, in 830. If the n-th stroke gesture was detected within the delay time, the vehicle 1 determines if the n corresponds to a multiple of k, in 840, where k refers to a natural number.

If the n corresponds to a multiple of k, i.e., the number of detected stroke gestures is a multiple of k, the vehicle 1 displays letters corresponding to the first to n-th stroke gestures on the text input interface, in 850. In this way, the user may visually check the letters corresponding to the input stroke gestures and immediately determine whether there is a typographical error in the input letters.

After the letters corresponding to the first to n-th stroke gestures are displayed on the text input interface, or if the n is not a multiple of k, the n increases again by one and the above procedure is repeated.

On the other hand, if the n-th stroke gesture was not detected within the delay time, the vehicle 1 displays letters corresponding to the first to (n-1)-th stroke gestures on the text input interface and stops the procedure, in 860.

According to embodiments of the vehicle and method for controlling the same, letters input at certain intervals are displayed based on the number of detected stroke gestures, thereby providing an environment to allow a typographic error in the input letters to be checked promptly.

Furthermore, an environment to show and automatically correct the typographic error in the input letters based on a pre-stored database may be provided.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

### DESCRIPTION OF THE SYMBOLS

1: VEHICLE
34: DISPLAY
100, 200: TOUCH INPUT DEVICE
300: CONTROLLER
400: STORAGE

What is claimed is:

1. A vehicle comprising:
a display configured to provide a text input interface;
a touch input device configured to sequentially detect a plurality of stroke gestures for inputting text through a touch unit;
a storage configured to sequentially store the detected plurality of stroke gestures; and
a controller configured to control the text input interface to display text corresponding to a plurality of stroke gestures stored each time the number of the stored plurality of stroke gestures corresponds to a multiple of a predetermined unit.

2. The vehicle of claim 1,
wherein the storage comprises
a first buffer configured to sequentially store the detected plurality of stroke gestures; and
a second buffer configured to initialized each time the number of the plurality of stroke gestures stored in the first buffer corresponds to a multiple of the unit and store the plurality of stroke gestures stored in the first buffer.

3. The vehicle of claim 2,
wherein the controller is configured to
control the text input interface to display text corresponding to a plurality of stroke gestures stored in the second buffer.

4. The vehicle of claim 2,
wherein the controller is configured to
control the text input interface to display text corresponding to a plurality of stroke gestures stored in the first buffer if there is no more stroke gesture detected within a predetermined delay time from when the last one of the detected plurality of stroke gestures is finished.

5. The vehicle of claim 4,
wherein the storage is configured to
initialize the first and second buffers if text corresponding to a plurality of stroke gestures stored in the first buffer is displayed.

6. The vehicle of claim 1,
wherein the storage comprises
a text database, and
wherein the controller is configured to
determine that there is a typographical error existing in the displayed text if the displayed text does not exist in the text database.

7. The vehicle of claim 6,
wherein the controller is configured to
control the text input interface to display similar text sets in the text database to the displayed text as recommended text sets for correction, if it is determined that there is a typographical error in the displayed text.

8. The vehicle of claim 6,
wherein the controller is configured to
if it is determined that there is a typographical error in the displayed text, check similar text in the text database to the displayed text and determine a difference between the checked text and the displayed text as the typographical error.

9. The vehicle of claim 8,
wherein the controller is configured to
control the text input interface to highlight the determined typographical error.

10. The vehicle of claim 8,
wherein the controller is configured to
control the text input interface to correct and display the determined typographical error based on the checked similar text.

11. A method for controlling a vehicle, the method comprising:
providing a text input interface;
sequentially detecting a plurality of stroke gestures for inputting text through a touch unit of the vehicle;
sequentially storing the detected plurality of stroke gestures; and
displaying text corresponding to the plurality of stroke gestures stored each time the number of the stored plurality of stroke gestures corresponds to a multiple of a predetermined unit through the text input interface.

12. The method of claim 11,
wherein sequentially storing the detected plurality of stroke gestures comprises
sequentially storing the detected plurality of stroke gestures in a first buffer of the vehicle; and
initializing a second buffer of the vehicle each time the number of the plurality of stroke gestures stored in the first buffer corresponds to a multiple of the unit and storing the plurality of stroke gestures stored in the first buffer in the second buffer.

13. The method of claim 12,
wherein displaying text comprises
displaying text corresponding to a plurality of stroke gestures stored in the second buffer through the text input interface.

14. The method of claim 12,
wherein displaying text comprises
displaying text corresponding to a plurality of stroke gestures stored in the first buffer through the text input interface if there is no more stroke gesture detected within a predetermined delay time from when the last one of the detected plurality of stroke gestures is finished.

15. The method of claim 14,
further comprising: initializing the first and second buffers if text corresponding to a plurality of stroke gestures stored in the first buffer is displayed.

16. The method of claim 11,
further comprising: storing a text database; and
determining that there is a typographical error existing in the displayed text if the displayed text does not exist in the text database.

17. The method of claim 16,
further comprising: displaying similar text sets in the text database to the displayed text as recommended text sets for correction through the text input interface, if it is determined that there is a typographical error in the displayed text.

18. The method of claim 16,
further comprising: if it is determined that there is a typographical error in the displayed text, checking similar text in the text database to the displayed text and determining a difference between the checked text and the displayed text as the typographical error.

19. The method of claim 18,
wherein displaying text comprises
highlighting the determined typographical error.

20. The method of claim 18,
wherein displaying text comprises
correcting and displaying the determined typographical error based on the checked similar text.
